(19) United States
(12) Patent Application Publication
(10) Pub. No.: US 2018/0009644 A1
(43) Pub. Date: Jan. 11, 2018

(54) AERIAL PLATFORM FOR AN INDUSTRIAL TRUCK

(71) Applicant: Jungheinrich Aktiengesellschaft, Hamburg (DE)

(72) Inventor: Jörg Ziemann, Hamburg (DE)

(21) Appl. No.: 15/641,571

(22) Filed: Jul. 5, 2017

(30) Foreign Application Priority Data
Jul. 5, 2016 (DE) 102016112264.5

(51) Int. Cl. B66F 11/04

(52) U.S. Cl. CPC B66F 11/04

(57) ABSTRACT

An aerial platform for an industrial truck has a one-piece base frame comprising a vertical mast strut configured to couple to the industrial truck and a floor plate configured as a place for at least one person to stand. The aerial platform further comprises at least two vertical posts defining an access opening and at least two horizontal side struts coupled the vertical mast strut and the at least two vertical posts.

### CROSS-REFERENCE TO RELATED INVENTION

This application is based upon and claims priority to, under relevant sections of 35 U.S.C. §119, German Patent Application No. 10 2016 112 264.5, filed Jul. 5, 2016, the entire contents of which are hereby incorporated by reference.

### BACKGROUND

The invention concerns an aerial platform for an industrial truck, particularly for an order picking vehicle.

Aerial platforms for industrial trucks are fundamentally known. For example, aerial platforms of this type are connected directly with the lift mast of the industrial truck. Aerial platforms can also be designed to be accommodated by a load fork of an industrial truck. The aerial platforms are raised and lowered by extending and retracting a telescopically extensible lift mast. A person located on the aerial platform can thus also reach high places, for example in a high-bay warehouse. Frequently, industrial trucks of this type are used as order picking vehicles, with the person located on the aerial platform able, for example, to remove the goods to be picked manually from the storage bay. The upward and downward movements of the aerial platform and the driving motion of the industrial truck are usually achieved with operator controls arranged on the aerial platform.

Aerial platforms are typically made of steel in prior art. Steel constructions provide high stability for the aerial platform, but also have very high weight. Furthermore, the manufacture of such aerial platforms from steel is expensive and complicated due to many welding processes. Depending on the industrial truck used, aerial platforms can be raised up to a height of about 10 m. Here it is particularly challenging to ensure sufficient stability of the industrial truck and/or the system comprised of industrial truck and aerial platform. Due to the high weight, aerial platforms are easily susceptible to vibrations when starting and braking the industrial truck with the mast extended.

Therefore, starting from the prior art mentioned, the object of the present invention is to provide an aerial platform for an industrial truck as well as an industrial truck with an aerial platform, in which the aerial platform is stable and at the same time inexpensive to manufacture and the system comprised of an industrial truck and aerial platform exhibits simple handling and high stability at the same time.

An aerial platform for a tire handling unit is known from WO 2013/115705. The aerial platform has an essentially rectangular base area with an entry to the aerial platform on the broadside. The back side opposite to the entry has a vertical strut connected with a continuous sheet for the back wall. Laterally, the standing platform is limited by a horizontal strut and a corresponding rail.

From U.S. Pat. No. 4,258,825 an aerial platform is known, which is adjustable in height via a telescopic lift mast. On one side, the aerial platform has an entry hatch, which is limited by a stationary safety bar.

### BRIEF SUMMARY OF THE INVENTION

The inventive aerial platform for an industrial truck has a base frame comprising a vertical mast strut for connecting with the industrial truck. A floor plate is configured as a place for at least one person to stand and at least two vertical posts define an access opening. At least two side struts connected with the vertical mast strut and the at least two vertical posts further define an interior space of the aerial platform. In particular, on both sides of the interior space, in each case one of the at least two side struts can extend from the vertical mast strut to one of the at least two vertical posts in each case. Thus in each case one side strut can be provided on two opposing sides of the interior space. Several side struts can also be provided on two opposing sides of the interior space, in particular two or three side struts, which connect the vertical mast strut with one of the vertical posts in each case. In an embodiment, the base frame of the aerial platform is fabricated from plastic in a single piece.

An inventive aerial platform with a base frame fabricated from plastic has a significantly lower intrinsic weight than aerial platforms according to prior art. By using an inventive aerial platform manufactured from plastic, the total mass of an industrial truck with such an aerial platform is reduced. In particular, if the aerial platform is raised by an industrial truck, the center of gravity of the system comprised of the industrial truck and aerial platform is consequently significantly lower than with the use of an aerial platform made of steel. This significantly increases the stability of the system comprised of the industrial truck and aerial platform. Furthermore, back-and-forth vibration of the extended aerial platform is also reduced. In particular, the system reacts to acceleration and delay processes of the industrial truck with less sluggishness than an aerial platform made of steel. Moreover, by manufacturing the base frame of the aerial platform in a single piece the stability of the aerial platform itself is also improved. In particular, increased rigidity and stability of the base frame of the aerial platform manufactured from plastic is achieved by fabrication as a single piece. Furthermore, the fabrication of an inventive base frame from plastic is less complex and less expensive than fabrication from steel. Compared to an aerial platform made of steel, there is no time-consuming subsequent machining required, particularly of the corners and edges of the aerial platform, because there are neither burs nor welding seams present. A further advantage of a base frame of an aerial platform fabricated from plastic in a single piece is great freedom of scope in design.

In an embodiment, the horizontal side struts stand out laterally from the vertical mast strut and transition into a side of the aerial platform with the bend, preferably one which is approximately right-angled. The horizontal side strut thus extends over the side of the aerial platform and likewise over the side of the aerial platform with the vertical mast strut. The aerial platform thus has no closed back wall, which gives a person standing on the aerial platform a clear view below in all directions, even in the direction of the back side opposite the entry. The horizontal side struts are connected in a section with a horizontal stabilization device, which is oriented horizontally. The stabilization device is, preferably designed as a horizontal plate, which achieves a connection between vertical mast strut and side strut able to bear a load. Such a stabilization device is advantageous, particularly in the embodiment in which the horizontal side strut forms a part of the back wall. Due to the horizontal construction, the stabilization device can be used as a work surface for the operator. In an embodiment, the vertical mast strut extends over the entire height of the aerial platform. The vertical mast strut begins with the floor plate and ends with an upper edge of the aerial platform. The vertical mast strut of the aerial platform preferably accommodates an upper end of the lift mast in order to be raised high. A particularly stable connection is possible here in that the vertical mast strut extends over the entire height

According to another embodiment, the base frame of the aerial platform can be fabricated in a single piece from a rotation-sintered plastic. According to a further embodiment, the base frame of the aerial platform can be fabricated in a single piece from a fiberglass-reinforced plastic. Rotation-sintered plastics are particularly simple to produce, while fiberglass-reinforced plastics create a particularly stable base frame. The manufacturing processes described can, for example, easily produce the edges and corners of the aerial platform in a rounded manner such that the risk of injury is minimized for a person using the aerial platform.

According to an embodiment, the aerial platform also has at least one barrier fabricated from a plastic, which is connected with one of the vertical posts of the base frame in a manner capable of pivoting. The at least one barrier can be arranged within the access openings formed by the two vertical posts so that a person can only enter the interior space of the aerial platform with the barrier open. The at least one barrier can be able to be pivoted from a closed position located between the two vertical posts in an open position inward into the interior space of the aerial platform or outward. A person located on the aerial platform can thus be secured against falling off the aerial platform. Two barriers can also be provided, wherein each of the barriers can be connected with one of the vertical posts in a manner capable of pivoting. Both barriers can be connected with the respective vertical posts in a manner capable of pivoting in such a way that they can be pivoted between a closed and an open position in order to enable a person to access the interior space of the aerial platform. The fabrication of the at least one barrier from a plastic leads to a further weight reduction of the aerial platform compared with an aerial platform in prior art made of steel. The at least one barrier can also be fabricated from a rotation-sintered plastic or from a fiberglass-reinforced plastic. Such fabrication from plastic also enables a plurality of design options for the at least one barrier. According to another embodiment, handles can be provided, which are fabricated in one piece together with the at least one barrier. According to a further embodiment, recessed grips can be provided, which are fabricated in one piece together with the at least one barrier and are recessed in the at least one barrier. The handles and/or recessed grips can thus be manufactured in a single step together with the at least one barrier.

According to a further embodiment, the base frame of the aerial platform further comprises at least one device, particularly a projection and/or a depression and/or an opening for accommodating control elements and/or switching elements. Such devices can also be fabricated from plastic in a single piece together with the base frame. Consequently, many additional functions can be integrated simply in the base frame fabricated from plastic. For example, control elements such as operating handles or switches could be integrated in such a device directly or using base panels. Cable ducting to run electrical lines can also be fabricated from plastic directly with the base frame. This further simplifies the fabrication of the aerial platform.

According to another embodiment, the aerial platform can have at least one work surface connected with the base frame. The at least one work surface can be used to accommodate goods, for example. Thus a person located on the aerial platform can, for example, remove goods from a high-bay warehouse and place them on the at least one work surface or take them from the at least one work surface and place them in the high-bay warehouse. The least one work surface can be connected with the vertical mast strut for this and be moved up and down with the aerial platform via an industrial truck. An industrial truck with an aerial platform with at least one work surface can also be used for repair and maintenance work at a great height, for example. The at least one work surface can serve to accommodate tools for this. The at least one work surface can also be fabricated from a plastic.

Fundamentally, all previously mentioned objects fabricated from plastic can be made by an injection molding process for example. A rotation sintering process can also be provided for fabricating the objects mentioned from plastic. Furthermore, a fiberglass-reinforced plastic can also be provided as a plastic.

An inventive industrial truck has a chassis with at least three wheels, a telescopically extensible lift mast connected with the chassis, and an aerial platform connected with the lift mast. The industrial truck can be an order picking vehicle in particular. The inventive aerial platform is connected with the lift mast of the industrial truck. The aerial platform is raised high by extending the lift mast. In the manner explained, the system comprised of industrial truck and aerial platform has better stability and in particular a lower center of gravity than would be the case with a system comprised of an industrial truck with an aerial platform fabricated from steel.

According to an embodiment, the inventive aerial platform can be connected with the lift mast of the industrial truck via the vertical mast strut of the aerial platform. In particular, the vertical mast strut can have a hollow space for accommodating an upper section of the lift mast of the industrial truck. The inventive aerial platform can thus be placed on the lift mast of the industrial truck via the vertical mast strut. The vertical mast strut can be open on a side to accommodate the upper section of the lift mast, particularly on an underside, to enable the insertion of the upper section of the lift mast in the vertical mast strut. The vertical mast strut can also be open on two or more sides. The vertical mast strut of the inventive aerial platform can also be connected with the lift mast of the industrial truck via fasteners. In particular, the vertical mast beam can be connected to the lift mast with screws or rivets, for example.

### BRIEF DESCRIPTION OF THE DRAWINGS

The invention will be explained below based on two exemplary embodiments thereof. These show in

FIG. 1 illustrates an isometric side view of an embodiment of an aerial platform, and

FIG. 2 illustrates an isometric side view of an embodiment of the aerial platform installed onto an industrial truck.

### DETAILED DESCRIPTION OF THE INVENTION

In the following, the same reference labels refer to the same objects if not otherwise specified.

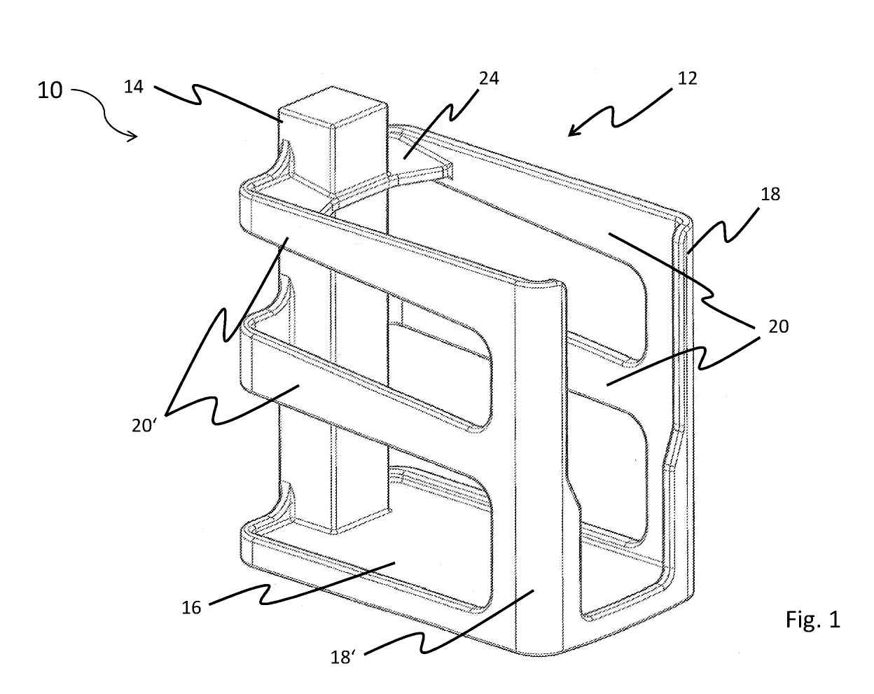

FIG. 1 shows a schematic representation of the inventive aerial platform 10. The base frame 12 comprises a vertical mast strut 14, a floor plate 16 as a place for one or more persons to stand, two vertical posts 18, 18′, and four horizontal side struts 20, 20′. The vertical mast strut 14 and the vertical posts 18, 18′ are connected with the floor plate 16 and extend perpendicularly from it. Two horizontal side struts 20 connect the vertical mast strut 14 with the vertical post 18 while two further horizontal side struts 20′ connect the vertical mast strut 14 with the vertical post 18′. Together with the vertical mast strut 14, the horizontal side struts 20, 20′ form a back side of the aerial platform 10 in which the side struts extend out from the vertical mast strut 14 and bend at a right angle, each to transition into a side. The sides of the aerial platform 10 are formed entirely by the horizontal side struts 20, 20′, while the back side is formed by the vertical mast strut 14 and the horizontal side struts standing out horizontally from it. Consequently, an interior space of the aerial platform 10 is created above the floor plate 16, which can serve as a place to stand for one or more persons. However, in an embodiment, only two side struts can also be provided, with one of the side struts connecting the vertical mast strut 14 with the vertical post 18 and the other connecting the vertical mast strut 14 with the vertical post 18′, forming an interior space. Between the vertical posts 18 and 18′ there is an opening which provides a person or multiple persons access to the interior space and the floor plate 16. Furthermore, FIG. 1 shows a projection or stabilization device 24 arranged on both sides of the vertical mast strut 14 for stabilizing the uppermost side strut on the vertical mast strut 14. The stabilization device 24 is flat and constructed like a slab.

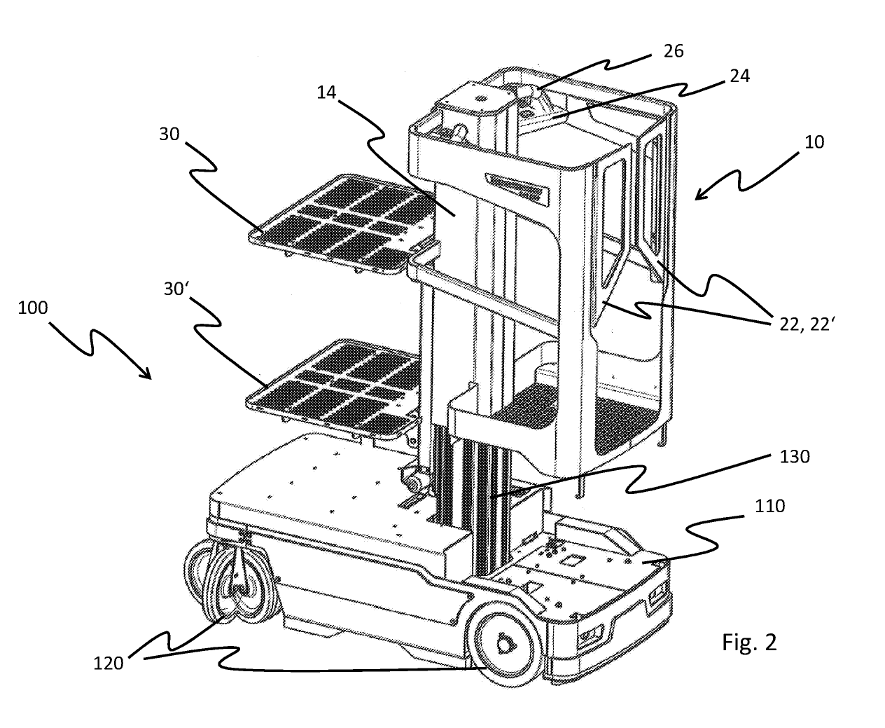

The base frame 12 shown in FIG. 1 is fabricated in one piece from a plastic. As explained, such fabrication enables particularly stable design and reduced weight at the same time. With the lesser effort and expense, the inventive aerial platform 10 can have many kinds of design elements. All edges and corners of the aerial platform 10 shown in FIG. 1 are rounded in such a way that the risk of injury is minimized for a person using the aerial platform 10. Compared to an aerial platform 10 made of steel, no time-consuming subsequent machining of the corners and edges is required. The stabilization device 24 can also be fabricated from plastic as one piece with the base frame 12. The stabilization device 24 can be a projection, which serves to accommodate control elements 26, as seen in FIG. 2.

FIG. 2 shows an industrial truck 100 with a chassis 110 and four wheels 120, of which only two can be seen in FIG. 2. The front wheel seen in FIG. 2 is a caster, which is shown turned in multiple directions. FIG. 2 also shows a telescopic, extensible lift mast 130 connected with the chassis 110 and an inventive aerial platform 10, which is connected with the lift mast 130. The aerial platform 10 is connected to the lift mast 130 of the industrial truck 100 via the vertical mast strut 14. The aerial platform 10 is raised or lowered by retracting and extending the lift mast 130 of the industrial truck 100. The vertical mast strut 14 of the aerial platform 10 is designed here in such a way that it accommodates the lift mast 130 completely in a retracted condition of the lift mast 130. However, the vertical mast strut 14 of the aerial platform 10 need not completely enclose the lift mast, but instead can be open on one or more sides.

The exemplary embodiment of the aerial platform 10 shown in FIG. 2 further comprises two barriers 22, 22′ which are connected in each case with a vertical post 18, 18′ of the base frame 12 of the aerial platform 10. The two barriers 22, 22′ can be pivoted into the interior space of the aerial platform 10 or away from it by electrical or manual means. A person using the industrial truck can thus gain access to the interior space and the floor plate 16 of the aerial platform 10 and is adequately secured against falling off the aerial platform 10 while working on the aerial platform 10. Using the control elements 26 connected with the stabilization device 24, a person located on the aerial platform 10 can operate the lift mast 130 of the industrial truck 100 and thus lower and raise the aerial platform 10. Furthermore, the person can control the industrial truck 100 using the control elements 26 and, for example, also drive with the lift mast 130 extended.

FIG. 2 also shows work surfaces 30, 30′ connected with the base frame 12 of the aerial platform 10. These work surfaces can be used by a person operating the aerial platform 10 to carry goods, for example to stock a high-bay warehouse or remove goods from this high-bay warehouse. The work surfaces 30, 30′ can also be used for tools if the industrial truck 100 with the inventive aerial platform 10 is used for work in high places.

### DRAWING REFERENCE LIST

10 Aerial platform
12 Base frame
14 Vertical mast strut
16 Floor plate
18 Post
18′ Post
20 Horizontal side struts
20′ Horizontal side struts
22 Barrier
22′ Barrier
24 Stabilization device
26 Control element
30 Work surface
30′ Work surface
100 Industrial truck
110 Chassis
120 Wheels
130 Lift mast

1. An aerial platform for an industrial truck comprising:
a one-piece base frame comprising,
a vertical mast strut configured to couple to the industrial truck,
a floor plate configured as a place for at least one person to stand,
at least two vertical posts defining an access opening, and
at least two horizontal side struts coupled to the vertical mast strut and the at least two vertical posts, wherein an interior space is defined by the at least two horizontal side struts, the vertical mast, and the at least two vertical posts.

2. The aerial platform according to claim 1, wherein the horizontal side struts extend laterally from the vertical mast strut and transition into a side of the aerial platform with a bend.

3. The aerial platform according to claim 1, further comprising a stabilization device configured to connect a section of the at least two horizontal side struts with the vertical mast strut.

4. The aerial platform according to claim 3, wherein the stabilization device is a horizontal plate.

5. The aerial platform according to claim 1, wherein the vertical mast strut extends from the floor plate over a height of the aerial platform.

6. The aerial platform according to claim 1, further comprising at least one barrier configured to pivotally coupled with one of the at least two vertical posts.

7. The aerial platform according to claim 6, wherein the at least one fabricated barrier is configured to pivot to define an open and a closed position.

8. The aerial platform according to claim 6, further comprising one or more handles fabricated in a single piece with the at least one barrier.

9. The aerial platform according to claim 6, further comprising recessed grips fabricated in a single piece with the at least one barrier.

10. The aerial platform according to claim 1, wherein the one-piece base frame comprises at least one structure configured to accommodate one or more control elements.

11. The aerial platform according to claim 1, further comprising at least one work surface coupled to the one-piece base frame.

12. The aerial platform according to claim 1, wherein the one-piece base frame is comprised of plastic.

13. The aerial platform according to claim 12, wherein the plastic is a rotation-sintered plastic.

14. The aerial platform according to claim 12, wherein the plastic is a fiberglass-reinforced plastic.

15. An industrial truck comprising:
a chassis;
at least three wheels coupled to the chassis;
a telescopically extensible lift mast coupled to the chassis; and
an aerial platform coupled to the telescopically extensible lift mast, the aerial platform comprising,
a base frame comprising,
a vertical mast strut configured to couple to the industrial truck,
a floor plate configured as a place for at least one person to stand,
at least two vertical posts defining an access opening, and
at least two horizontal side struts coupled to the vertical mast strut and the at least two vertical posts, wherein an interior space is defined by the at least two horizontal side struts, the vertical mast, and the at least two vertical posts.

16. The industrial truck according to claim 15, wherein the vertical mast strut is configured to couple the aerial platform to the lift mast of the industrial truck.
